(19) United States
(12) Patent Application Publication
(10) Pub. No.: US 2004/0088378 A1
(43) Pub. Date: May 6, 2004

(54) Method and system for viewing stored print jobs through an embedded web server interface

(76) Inventor: Travis N. Moats, Nampa, ID (US)

Correspondence Address: HEWLETT-PACKARD COMPANY, Intellectual Property Administration, P.O. Box 272400, Fort Collins, CO, 80527-2400, US

(21) Appl. No.: 10/288,360

(22) Filed: Nov. 4, 2002

(51) Int. Cl. G06F 15/16

(52) U.S. Cl. 709/219; 709/217

(57) ABSTRACT

A method and system for displaying print jobs, or other data, stored in a memory of a printing device on a web browser. Using a web browser operating on a computing device, an embedded web server associated with a printing device may be accessed for retrieving lists of data stored in a memory of said printing device, for viewing images of said data, and for manipulating said data.

### FIELD OF THE INVENTION

The present invention involves methods and systems for viewing print jobs or other data stored by a printing device. More particularly, the present invention provides a method and system for a user to access one or more print jobs stored on a printing device via a web browser for viewing, or otherwise manipulating, a print job prior to printing.

### BACKGROUND OF THE INVENTION

Printing devices, such as printers, copiers, multifunction devices, and the like, continue to evolve as technology advances. Far from the dot-matrix printers of yesteryear, today's printing devices include multiple capabilities and options for creating and customizing document production.

One of the capabilities offered by today's printing devices is the ability to store large amounts of data. Many printing devices include built-in memory for storing data to be manipulated or printed by the printing device. Data stored in a memory of a printing device is received from a computer or other device in communication with the printing device. Data is stored in separate files within the printing device memory. Each file typically constitutes a single print job. A print job may include a single document or a set of documents that have been sent to the printing device for hardcopy production. In some instances, a single print job may be defined, or shared, by multiple data files.

A printing device may be programmed to immediately print any data files sent to the printing device. In other instances, a data file may be sent to the printing device for delayed printing wherein the printing device stores the data file in memory until a predetermined time before printing arrives. Alternatively, a print job or data file may be sent to the memory of a printing device for indefinite storage or, in others words, for an unknown amount of time. Print jobs sent to indefinite storage reside in the memory of a printing device and are not erased following printing. Rather, the print job is stored for on-demand printing that may occur multiple times.

Printing devices having memories for storing print jobs also typically include programming or functionality that allows a user to view the file names of the print jobs stored in a printing device memory. Names for the print jobs stored in the printing device memory may be randomly created, or they may include identifying indicia, such as a customized, or identifying, name. In some instances, additional information may be displayed with the file names of the print jobs. For instance, a user identification, or device identification, may be displayed to indicate the origin of the print job, be it a user name or a device name. Priority assignments may also be indicated if a printing priority system is available to the printing device as known.

Print job information displayed to a user of a printing device is often displayed as a print queue. The print queue lists the print jobs stored in the printing device memory in the order that the print jobs are assigned to be printed. Sometimes, a user may promote a print job within the printing queue in order to print a stored print job sooner. A separate print job list for displaying indefinitely stored print jobs may also be accessed by a user for selecting an indefinitely stored print job for printing.

Although a user is able to view the names and other information associated with the available print jobs stored in a printing device memory, a user is not able to view the actual print job. No method or system currently exists for viewing a print job stored in a printing device memory. The inability to view a job before printing, especially where an indefinitely stored print job is being printed, may result in the incorrect print job being printed.

For instance, a form commonly used by the employees of a business may be stored in a memory of a print device so that the employees may print the form from the printing device whenever the form is needed. Using the functionality of the printing device, an employee may scroll through the list of indefinitely stored print jobs and select the form that they wish to print. However, if two similar forms exist, with similar names, an employee may not know which form is the actual form that they need. Without the ability to view how the print job for each form will look, the employee must guess which form is the desired form. If the wrong form is selected and printed, the unselected form must be selected for printing. This process is inefficient and may lead to the unnecessary printing of numerous forms in order to print the desired form.

Problems similar to that just described are more frequently encountered in those situations where large numbers of forms or print jobs are stored in a printing device memory. These problems also persist in those instances where the file names of the print jobs stored in a printing device memory are random file names instead of file names having identifying characteristics, such as identifiable file names.

The inability of a printing device to display a preview of a print job in a print queue or stored in memory is unfortunate. Currently, there are no systems or methods for viewing documents stored on a printing device other than by printing the particular document. A system and method for allowing a user to preview a print job stored in a printing device memory before selecting the print job for printing is desirable. In addition, the ability to delete a previewed print job from a printing device memory may be advantageous.

### BRIEF SUMMARY OF THE INVENTION

The present invention involves methods and systems for viewing print jobs or other data stored by a printing device. More particularly, the present invention provides a method and system for a user to access one or more print jobs stored on a printing device via a web browser for viewing, or otherwise manipulating, a print job prior to printing.

Using a web browser operating on a computing device, a user may communicate with an embedded web server of a printing device for retrieving and viewing data from a memory of the printing device. A list of print job names or other data file names may be viewed using a web browser in communication with the embedded web server of a printing device. Various print jobs or other data may be selected for viewing in an image format on the web browser. Once viewed, the image or associated print job or other data may be printed, deleted, or otherwise manipulated using commands allowed by the web server-enabled printing device.

In one embodiment of the present invention, a user may connect to a web server enabled printing device using a web browser operating on a computer system. A communication link between the web browser and the printing device may be accomplished via the Internet or other communication methods. Once connected, a user may use the web browser for viewing data stored in a memory of the printing device. For instance, a list of print job file names may be displayed on the connected web browser. Selecting a file name triggers the embedded web server or functions and programs associated therewith to retrieve a copy of the file associated with the selected file name and to convert the copy of the file into an image format that may be viewed using a web browser. The converted image may then be displayed on the connected web browser. For example, a program such as a ChaiService™, associated with Hewlett-Packard's ChaiServer™ operating on a printing device, may retrieve a print job file, copy the file, convert the copied file into a web browser viewable image, and display the image on a web browser. Thus, a web browser user may view a print job prior to printing, or otherwise manipulating, the print job.

In another embodiment of the present invention, a private job or secure data file stored in a memory of a printing device may be viewed on a web browser. In addition to converting a selected print job file to a web browser viewable image, functions or programs, such as Hewlett-Packard's ChaiServices, may be used to authenticate access to the selected data. An authentication form for authorizing access to a selected file may be displayed on a web browser, prompting the user to enter authorization data such as user names and personal identification numbers. Once entered, this data may be compared to the authentication data that is required to view the selected data. A ChaiService™ may compare the data and provide authorized users access to selected files.

The various embodiments of the present invention provide a secure and more efficient method for viewing and manipulating print jobs, or other data, associated with printing devices.

### BRIEF DESCRIPTION OF THE SEVERAL VIEWS OF THE DRAWINGS

While the specification concludes with claims particularly pointing out and distinctly claiming that which is regarded as the present invention, the present invention can be more readily ascertained from the following description of the invention when read in conjunction with the accompanying drawings in which:

FIG. 1 illustrates a block diagram of different systems that may be used to carry out the various embodiments of the present invention;

FIGS. 2A, 2B, and 2C illustrate flow diagrams of the various steps and logic that may be performed to execute the various embodiments of the present invention;

FIG. 3 illustrates an example of a web browser display that maybe used to list available print jobs stored in a memory of a printing device;

FIG. 4 illustrates an example of a web browser display that may be used to view a print job stored in a memory of a printing device and perform functions on the print job; and

FIG. 5 illustrates an example of a web browser display that maybe used to authorize various embodiments of the present invention.

### DETAILED DESCRIPTION OF THE INVENTION

The present invention involves methods and systems for viewing print jobs or other data stored by a printing device. More particularly, the present invention provides a method and system for a user to access one or more print jobs stored on a printing device via a web browser for viewing or otherwise manipulating, a print job prior to printing.

As used herein, the term “memory” refers to any information or data storage device such as disk drives and computer-like memory (e.g., RAM, PROM, re-writeable disks, etc). In a general embodiment of the present invention, a printing device is web server enabled for providing communications between the printing device and a computer or network workstation computer system. Using a web browser operating on a computer system, a user may surf to the embedded web server of the printing device to obtain a list of data or print jobs stored in a memory of the printing device. A user may select one or more print jobs for preview.

Once selected, an image of the print job maybe displayed in the web browser operating on the computer system so that the user may preview the print job as it will look when printed. The user may optionally perform various functions or operations on the print job using the web browser. Thus, a user is provided with a method and system for previewing print jobs stored in a printer memory.

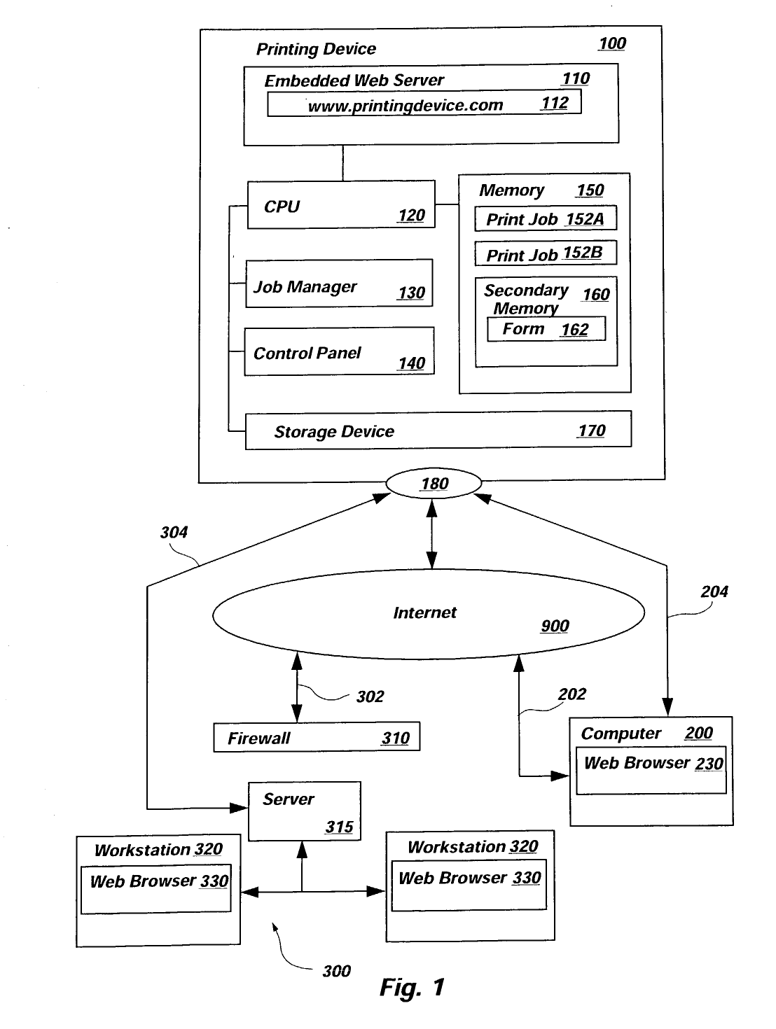

Numerous systems for carrying out the various embodiments of the present invention are illustrated in FIG. 1. A printing device 100 may comprise a printer, a copier, a multifunction device, or other printing device capable of receiving data for storing and printing. Printing device 100 may include an embedded web server 110 for providing communications between printing device 100 and other devices as known. The embedded web server 110 may include a uniform resource locator (URL) 112 associated with printing device 100 for facilitating communications between printing device 100 and other devices. In the illustrated embodiment, the character-based URL 112 for printing device 100 is “www.printingdevice.com.” One or more central processing units (CPU) 120 may control the operations of printing device 100. A job manager 130 associated with CPU 120 may include programming or other instructions for carrying out and organizing the print capabilities of printing device 100. Printing device 100 may also include a control panel 140 for displaying information, such as print job file names, and receiving instructions or other information from a user of printing device 100. One or more memories 150 may also be incorporated in printing device 100 as known. A secondary memory 160 may be included as part of memory 150 or as a separate memory for storing print jobs or other data that printing device 100 may use on a repetitive basis. Printing device 100 may also include a storage device 170 for storing print jobs or other data. Communications ports 180, as known, may also be included with printing device 100.

The use of embedded web servers 110 with printing devices is known. Many internal and external devices may be incorporated with printing devices for providing embedded web server 110 functionality. For example, Hewlett-Packard Company manufactures a number of internal and external print servers that include embedded web server 110 capabilities.

More recently, software solutions have been developed for providing enhanced web page support to individual devices, including printing devices. Hewlett-Packard's ChaiServer and ChaiServices are prime examples of such software solutions. Using the ChaiServer application, a printing device 100 may have a web page of its own, identified by a URL 112. The ChaiServer, in turn, allows a printing device 100 to be accessed through a web browser from anywhere.

ChaiServices are platform-independent, dynamically loadable, plug-in objects that may be used to perform different tasks and functions. Using ChaiServices with an associated ChaiServer, various operations may be programmed and incorporated with a printing device to enhance functionality of the device. ChaiServers and ChaiServices are summarized in the “hp chaiserver overview white paper” published in September 2000, which is incorporated herein by this reference.

It is to be understood that other embedded web server 110 technology or software solutions may be incorporated in a printing device 100 for executing the various embodiments of the present invention.

The CPU 120, job manager 130, and control panel 140 of printing device 100 may be used to carry out the everyday operations of printing device 100. The use of these components with printing devices 100 is known.

Memory 150 may include any type of memory commonly used with printing devices 100. For instance, memory 150 may be read-only memory (ROM), random-access memory (RAM), flash memory, SDRAM memory, or the like. Data, or print jobs 152A, 152B (collectively referred to herein as print job(s) 152), are commonly stored in memory 150 until printing device 100 prints a hard copy of the print job 152. When the time for printing a print job 152 arrives, job manager 130 retrieves the print job 152 from memory 150 and causes a hard copy of the print job 152 to be printed by printing device 100.

A secondary memory 160 may also include any type of memory commonly used with printing devices 100. Secondary memory 160 may be a portion of memory 150 reserved for special purposes or a separate memory used to store specific information. Typically, a secondary memory 160 may be used to store print jobs 152, or data that is to remain stored in the secondary memory 160 even after printing. For instance, a form 162 commonly used by a user on a repetitive basis may be stored in secondary memory 160 for on-demand printing. A user may select to print the form 162 using printing device 100. Unlike a print job 152 stored in memory 150, however, the data file for form 162 is not erased or discarded from secondary memory 160 after printing by printing device 100. Instead, the data file representing form 162 remains in the secondary memory 160 so that it may be printed again and again as desired.

Storage device 170 may include any type of storage device capable of storing or retrieving data. For instance, storage device 170 may include a hard drive, an optical drive, a zip drive, a compact disc drive, a digital video disk drive, or other similar device for storing and retrieving data to fixed or readable media. Data, such as forms or other print jobs, may be stored on storage device 170 instead of, or in addition to, being stored in secondary memory 160. Similarly, a user may import a print job 152 into memory 150, or secondary memory 160, from a storage media using storage device 170.

Printing device 100 may be connected to Internet 900 for sending and receiving data via the Internet 900. Optionally, printing device 100 may be connected to, or in communication with, a network computer system 300 using communications familiar with network computer systems 300. Printing device 100 may also be connected to a computer 200 for direct communications as known.

A computer 200 including componentry and devices, commonly associated with computers 200, may include an Internet connection 202 for communicating with other devices via the Internet 900. A web browser 230 may operate on computer 200 for sending, receiving, and viewing data received via Internet 900 or an intranet as known. Utilizing web browser 230, computer 200 may communicate with printing device 100 via Internet 900. Many different web browsers 230 exist and may be used with the various embodiments of the present invention.

Alternatively, computer 200 may include a direct communication link 204 with printing device 100 for sending and receiving data between computer 200 and printing device 100. Web browser 230 operating on computer 200 may communicate with web server 110 operating on printing device 100 using the direct communication link 204.

A computer 200 may be any type of computing device capable of operating a web browser 230, including, but not limited to, personal computers, personal digital assistants, cellular phones, handheld computing devices, pagers, and the like.

A network computer system 300, including a firewall 310, one or more servers 315, multiple workstations 320, and an Internet connection 302 for sending and receiving data via Internet 900, may also be used with the various embodiments of the present invention. A workstation 320 may be a computer workstation, as is commonly used with network systems. A web browser 330 may operate on one or more workstations 320 for sending, receiving, and viewing data. For instance, a workstation 320 may communicate with printing device 100 using a web browser 330 and Internet connection 302.

Network computer system 300 may also include one or more direct communication links 304 with printing device 100 for sending and receiving data between network computer system 300 and printing device 100. A web browser 330 operating on a workstation 320 may communicate with web server 110 operating on printing device 100 using the direct communication link 304.

In one embodiment of the present invention, a user operating computer 200 loads or otherwise executes a web browser 230 for previewing print jobs stored on printing device 100. Using web browser 230, a user may surf, or otherwise connect, to the URL 112 associated with the embedded web server 110 of printing device 100 through an Internet connection 202. After connecting to the Internet 900 with web browser 230, a user may enter the URL 112 “www.printingdevice.com” in the web browser 230 to connect to the web server 110 of printing device 110.

Once the user is connected with web server 110, the user may obtain a list of pending print jobs 152 stored in a memory 150 of printing device 100. Additionally, a user may obtain a list of print jobs, or forms 162, stored in a secondary memory 160 or on storage device 170. The lists of print jobs 152 and forms 162 may be displayed on computer 200 as part of a web page being shown by web browser 230. A user may select one or more print jobs 152, or forms 162, for viewing using web browser 230 and submit the request to embedded web server 110 of printing device 100. A selected print job 152 or form 162 may be converted to a data type that may be displayed on a web browser 230. Once converted, the data is sent to web browser 230 for viewing by the user.

In addition to viewing the selected print job 152, or form 162, a user may be provided with options to manipulate the print job 152, or form 162, with printing device 100. For instance, a user may be presented with the option to print the print job 152 or form 162. Alternatively, the user may decide to delete the print job 152, or form 162, from the memory 150, secondary memory 160 or other storage device 170. An option selected by a user may be sent from the web browser 230 to the web server 110, where the job manager 130 receives the user selection and performs the requested option.

Alternatively, computer 200 may communicate with printing device 100 using a direct communication link 204. Using a direct communication link 204, web browser 230 may communicate directly with embedded web server 110 to carry out the various embodiments of the present invention, as previously explained.

In an alternate embodiment of the present invention, the data stored on printing device 100 may be secured such that only certain users may access the data. For instance, a print job 152B may be a secured print job, or private-stored print job, requiring verification of a username and password before a user is allowed access to the print job 152B, or is provided an option to manipulate the print job 152B. Secure print jobs 152B are known and are becoming more popular, especially in enterprise situations where multiple users share access to a single printing device 100.

Access to view secured print jobs 152B may be allowed using various embodiments of the present invention. In those instances where a print job 152 or form 162 selected by a user using a web browser 230 is a secured print job, the job manager 130 of the printing device 100 requires the user to enter the appropriate username and password before allowing the user to view or otherwise manipulate the selected print job 152 or form 162. A security page may be passed to the web browser 230 requesting that the user enter the appropriate username and password to access the chosen data. Upon entering a username and password, a user may submit the information to the job manager 130 for security clearance through web server 110. Communication of usernames and passwords between web browser 230 and embedded web server 110 may be accomplished using secure transmissions associated with Internet 900 transactions, as known. If the proper username and password are submitted, the job manager 130 may allow the user to view and manipulate the secured file or print job in the same manner that unsecured data may be viewed and manipulated.

Alternatively, a web browser 330 operating on a workstation 320 associated with a network computer system 300, may be used in the same manner as that used with computer 200 to access, view, and operate on the print jobs 152 and forms 162 stored by printing device 100. A web browser 330 operating on a workstation 320 may also communicate with embedded web server 110 of printing device 100 using an Internet connection 302 or via a direct communication link 304.

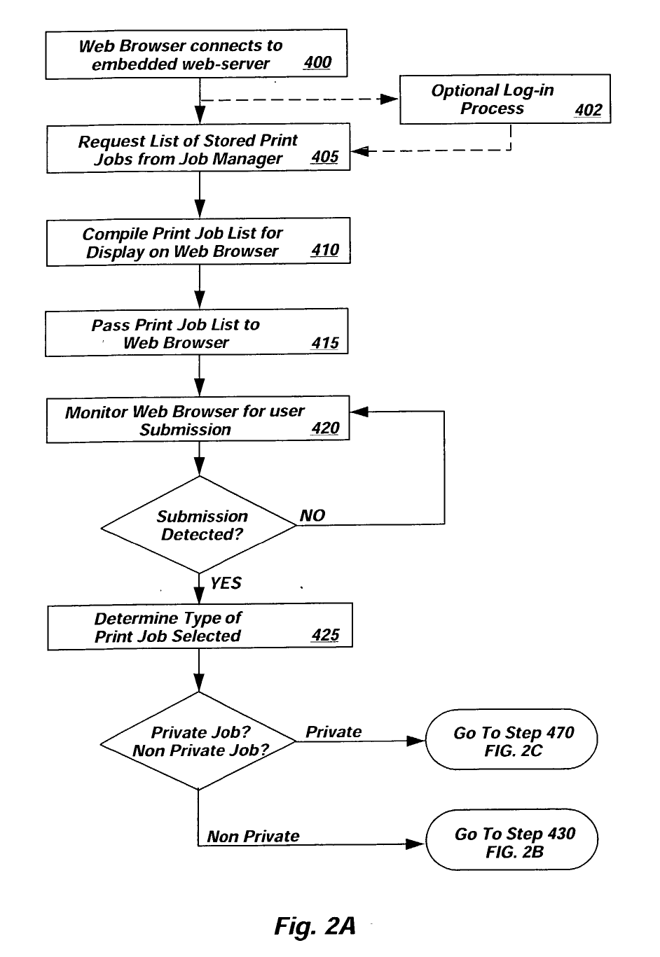

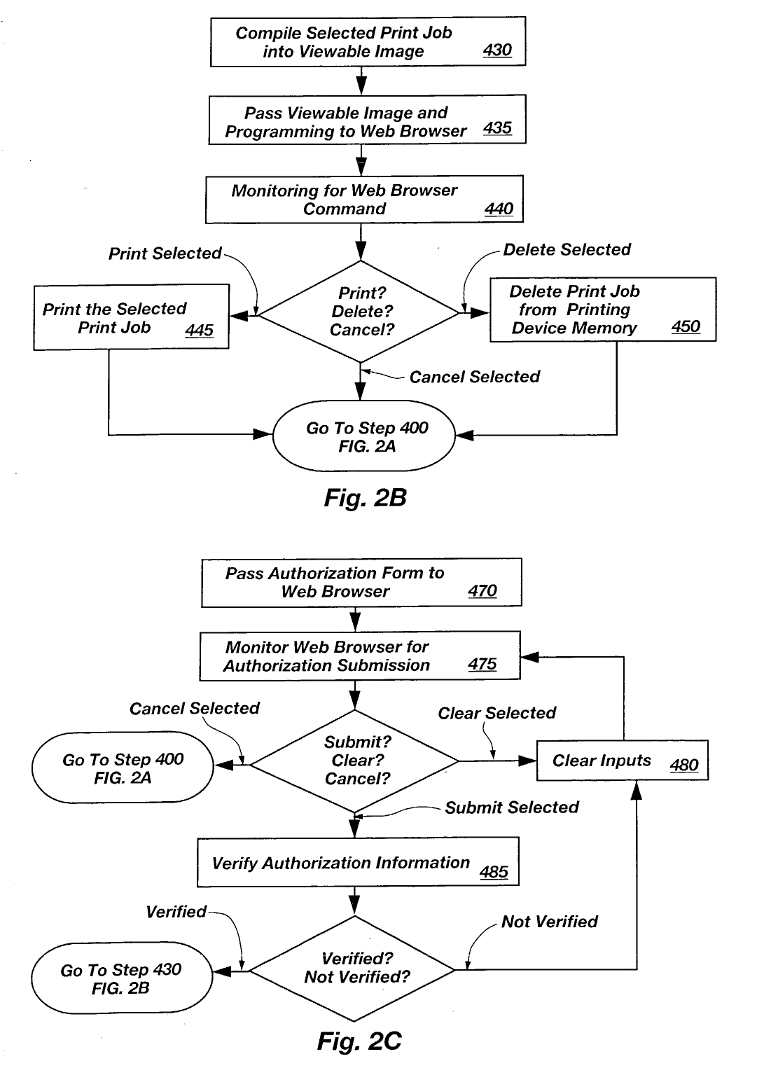

The various embodiments of the present invention may be more readily understood with reference to FIGS. 2A through 2C, which illustrate flow diagrams of the steps and logic involved with the various embodiments of the present invention. In addition, FIGS. 3 through 5 illustrate various screen-shots that may appear on a web browser 230 utilizing the present invention. A ChaiServer and ChaiServices, or other programming associated with printing device 100, may be used to carry out the various embodiments of the present invention.

Initially, a web browser, operating on a computer, a workstation, or other device, connects 400 to a URL associated with an embedded web server of a printing device using known methods as illustrated in FIG. 2A. Preferably, the URL associated with the embedded web server is dedicated to performing the various embodiments of the present invention. Once connected, a list of stored print jobs is requested 405 from a job manager associated with the printing device. The list of stored print jobs received from a job manager is compiled for display 410 on a web browser and may be passed 415 to the web browser for display. Additional information, or programming, may also be compiled with the list of stored print jobs, such as programming that allows a user to select and submit a print job for viewing. Typically, a ChaiService may be employed to request, compile, and pass the list of stored print jobs to a web browser. An example of a list of stored print jobs and other programming compiled by a ChaiService and displayed on a web browser for use with the present invention is illustrated in FIG. 3.

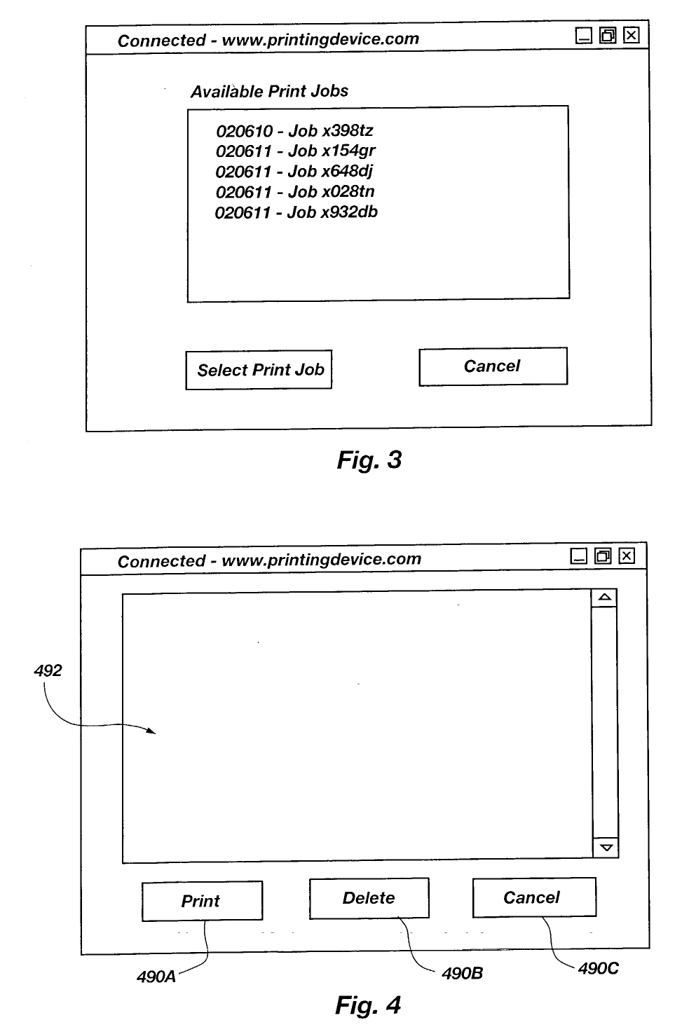

Once a list of stored print jobs is passed to a web browser, the connection between the web browser and the web server is monitored 420 for a submission from the web browser. If a submission is not received, the connection continues to be monitored 420. Once a submission is received, a ChaiService, or other function, is executed for determining the type of stored print job selected 425 by a user of the web browser. For instance, a selected print job may be a secure, or private, print job requiring a user to enter an authorized password and username before being allowed access to the print job. On the other hand, a selected print job may be a nonsecure print job. If the selected print job is a nonsecure print job, the selected print job may be compiled 430 into a web browser viewable image as illustrated in FIG. 2B. To accomplish this, a ChaiService, or other similar program, receives a copy of the selected print job file in the format in which the selected print job file is stored by the printing device. Usually, a print job is stored in a file format tailored for the print device. Examples of common printer file formats include printer control language (PCL), (PCL-XL), (PS), Hardware Ready Bits (HRB), or other print-ready job formats. A ChaiService may be programmed for converting a print job file format to a web browser-friendly format, such as Joint Photographic Experts Group format (JPEG), Graphical Interchange Format (GIF), Tagged Image File Format (TIFF), Portable Document Format (PDF), Bitmap (BMP), or other file format that may be displayed by a web browser. In addition to converting the selected print job to a viewable format, a ChaiService may compile or create a set of programming codes for receiving instructions from the user of a web browser. The converted image and compiled programming may then be passed 435 to a web browser for viewing. An example of a web browser screen-shot that may result from these steps is illustrated in FIG. 4.

The connection between the web browser and web server is again monitored 440 for a command from the web browser that may be used to print or otherwise manipulate the selected print job. The connection may be monitored 440 until a command is detected. As illustrated in the screen-shot of FIG. 4, three command buttons 490A-C appear with the image of the selected print job. A print command button 490A may be selected by a user to print the selected print job. A delete command button 490B may be selected by a user to delete the selected print job from a memory of the printing device. Selection of a cancel command button 490C allows the user to cancel the current action and return to the list of available print jobs for selecting another print job to view.

If the print command button 490A is selected by a user, the displayed, or selected, print job is printed 445 by the printing device. Following printing selection, the web browser may be reconnected 400 to the embedded web server for repeating the process. If the delete command button 490B is selected by a user, the displayed, or selected, print job is deleted 450 from the memory of the printing device and the web browser may be reconnected 400 to the embedded web server for repeating the process. If a user selects the cancel command button 490C the web browser may be reconnected 400 to the embedded web server for repeating the process. Additional commands or print job manipulation options may be included or programmed for operating on the selected print job and displayed with the viewable print job image or in a separate web browser window. The various embodiments of the present invention are not limited by the number of, or the type of, options that may be made available to a user of the invention.

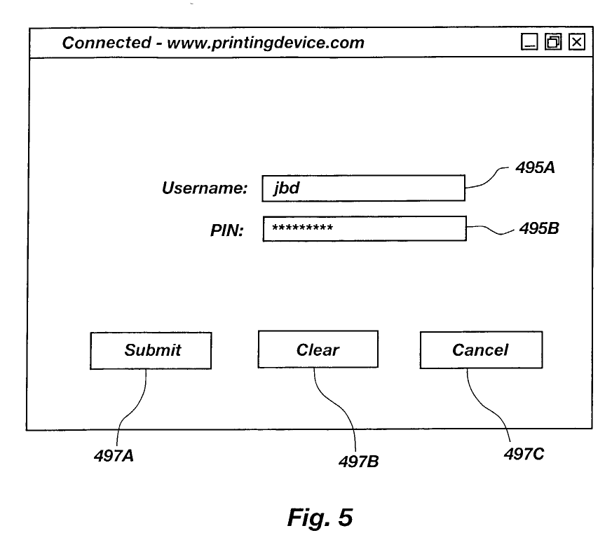

In those instances where it is determined 425 that a selected print job is a secure, or private, print job, a web browser user may be required to enter an authorized code or set of codes before being allowed access to the selected print job. Upon determining 425 that a selected print job is a secure print job, a ChaiService, or other similar programmed function, passes 470 an authorization form to the web browser for obtaining an authorization code or set of authorization codes as illustrated in FIG. 2C. An authorization form passed to a web browser for accessing a secure print job may be similar to the example screen-shot illustrated in FIG. 5. The example authorization form includes a first input 495A for receiving a username and a second input 495B for receiving a personal identification number (PIN) from a user (collectively referred to as inputs 495). A submit command button 497A, a clear command button 497B, and a cancel command button 497C also appear on the displayed authorization form. Using a web browser, a user may input his/her username and PIN in the designated inputs 495. One or more of the inputs 495 may be associated with security characters to prevent others from reading the information inputted by a user. For instance, the second input 495B, for receiving a user's PIN, may be masked with asterisk (*) characters to hide a user's PIN from prying eyes. Upon completing entry of the requested information, a user may submit the information to the printing device by selecting the submit command button 497A.

It is understood that authorization forms may contain one or more inputs 495 for receiving information for authorizing access to a print job from a user. Authorization forms, and methods for using authorization forms, such as those used with the present invention, are known and may be adapted, or customized, as desired.

Again referring to FIG. 2C, the web browser is monitored 475 for an authorization submission until a submission is received. If the submission received corresponds to the clear command button 497B, the inputs 495 of the authorization form are cleared 480 so that a user may re-enter the requested authorization information and the web browser is again monitored 475. If a cancel submission is received, corresponding to selection of cancel command button 497C, the authorization action is canceled and the web browser is reconnected 400 to the embedded web server to repeat the process. If selection of the submit command button is detected and the inputs 495 contain values, then authorization may be verified using the username and PIN submitted 485. The username and PIN may be verified against a username and PIN stored with the selected print job, or as an additional file, as known with secure documents stored on printing devices. Upon verification that a user is entitled to view or otherwise manipulate the selected print job, a ChaiService compiles 430 the selected print job into a viewable image and proceeds in the same fashion as with an unsecured document. If the authorization information submitted by the user is not verified, an authorization form may again be passed 470 to the web browser to allow the user to attempt verification again. Alternatively, or after a number of failed authorization attempts, a ChaiService may reconnect 400 the web browser to the embedded web server to begin the process anew.

An optional log-in process 402 may also be included with the various embodiments of the present invention as illustrated in FIG. 2A. Before a user may access any data stored on the printing device, a ChaiService, or other similar function, may be used to authorize access rights to the printing device data. The log-in process 402 may be carried out in a manner similar to the way in which the authorization process for secure, or private, print jobs is carried out.

Communications between a printing device web server and a web browser during any stage of the processes of the present invention may include encrypted communications as known with web browser and web server communications. The use of encrypted communications may be especially preferable for submitting authorization information, such as usemames and PINs, for authorization. The use of encrypted communications may also be desired if a user must log-on to the service of the present invention before being allowed access to the data stored on a printing device.

Utilizing the present invention, a user stationed at a workstation 320 on a network computing system 300 may view various print jobs stored on a printing device 100 connected to the network computing system 300. Using a web browser 330 operating on the workstation 320, the user may-connect to the embedded web server 110 of the printing device 100 by directing web browser 330 to connect to the URL 112 “www.printingdevice.com.” Once connected, a programmed function or functions, such as a ChaiService, obtains a list of the available print jobs stored in a memory 150, in a secondary memory 160, or on storage device 170 of printing device 100. The available print jobs are displayed by web browser 330 to the user. If an unsecured print job is selected for viewing, the print job file format may be converted to a file format that may be viewed by web browser 330. An image of the print job, in the new file format, may be displayed on web browser 330. If the selected print job is a secure print job, an authorization form may be displayed on web browser 330 for retrieving authorization information from the user before allowing the user access to the selected print job. If the correct authorization information is submitted, the selected print job may be converted to a displayable format and displayed on web browser 330. A user may choose to print, delete, or otherwise manipulate the displayed print job using command buttons passed from web server 110 and displayed on web browser 330.

In an alternative embodiment of the present invention, a printing device 100 may include a screen or display large enough for displaying images of print jobs 152 or forms 162 stored by printing device 100. Some larger, enterprise, printing devices 100 are equipped with built-in computer systems, or displays, capable of carrying out the various embodiments of the present invention. Instead of using a web browser operating on a computer 200 or workstation 320, a web browser operating on the computer system or display of the printing device 100 may be used to view and manipulate print jobs or other data stored by printing device 100. A web browser operating on a computer system associated with a printing device 100 would carry out the various embodiments of the present invention in the same manner that a computer 200 or workstation 320 would carry out the various embodiments of the present invention.

The various embodiments of the present invention provide a method and system for viewing secured and nonsecured data stored on a printing device. Using the present invention, users may be provided greater access to printing device data and additional options for manipulating or otherwise using such data.

Having thus described certain preferred embodiments of the present invention, it is to be understood that the invention defined by the appended claims is not to be limited by particular details set forth in the above description, as many apparent variations thereof are possible without departing from the spirit or scope thereof as hereinafter claimed.

What is claimed is:

1. A method for viewing a print job, comprising:
using a web browser operating on a computer system for accessing a memory of a printing device;
retrieving a list of print jobs stored in said memory of said printing device;
selecting a print job from said list of print jobs for viewing;
compiling said selected print job to a web browser friendly format; and
displaying said selected print job in said web browser.

2. The method of claim 1, wherein said computer system is selected from the group consisting of a personal computer, a network workstation, a personal digital assistant, a handheld computing device, a cellular phone, and a pager.

3. The method of claim 1, wherein using a web browser operating on a computer system for accessing a memory of a printing device comprises: executing said web browser on said computer system; and
using said web browser to surf to a uniform resource locator associated with said printing device.

4. The method of claim 3, wherein said using said web browser to surf to a uniform resource locator associated with said printing device comprises:
entering a uniform resource locator associated with a web server-enabled printing device; and
establishing a communication link between said web browser and said web server.

5. The method of claim 4, wherein said communication link between said web
browser and said web server is selected from the group consisting of an Internet communication link, a network communication link, a direct communication link, and a wireless communication link.

6. The method of claim 1, wherein said retrieving a list of print jobs stored in said memory of said printing device comprises:
retrieving a list of file names of said print jobs stored in said memory of said printing device;
passing said list of file names to said web browser; and
using said web browser for displaying said list of file names.

7. The method of claim 6, wherein said selecting a print job from said list of print jobs for viewing comprises using said web browser for selecting at least one print job file name from said list of file names.

8. The method of claim 1, wherein said compiling said selected print job to a web browser friendly format comprises:
retrieving a copy of said selected print job from said memory of said printing device; and
using a web browser plug-in to convert said copy of said selected print job to said web browser friendly format.

9. The method of claim 8, wherein said web browser plug-in comprises a ChaiService.

10. The method of claim 1, wherein said web browser friendly format is selected from the group consisting of JPEG, GIF, TIFF, PDF, and BMP formats.

11. The method of claim 1, wherein said displaying said selected print job in said web browser comprises displaying said selected print job in an image format selected from the group consisting of JPEG, GIF, TIFF, PDF, and BMP.

12. The method of claim 1, further comprising storing said print job in said memory of said printing device prior to using said web browser to access said memory.

13. The method of claim 1, wherein said printing device is selected from the group consisting of a printer, a copier, a scanner, and a multifunction device.

14. The method of claim 1, further comprising:
providing at least one authorization code; and
verifying authorization rights to said selected print job before compiling said selected print job to said web browser friendly format.

15. A method for viewing a print job stored in a memory of a printing device, comprising:
using a web browser operating on a computer to communicate with a web server associated with said printing device;
retrieving a list of file names from said memory of said printing device;
displaying said list of file names on said web browser;
selecting at least one file name from said list of files names for viewing;
verifying authorization to at least one file associated with said selected at least one file name;
converting a copy of said at least one file associated with said selected at least one file name to a web browser friendly format; and
displaying said converted copy of said at least one file on said web browser.

16. The method of claim 15, further comprising displaying command buttons with said displayed list of file names on said web browser for executing functions associated with said displayed list of file names.

17. The method of claim 15, further comprising displaying at least one command button with said converted copy of said at least one file on said web browser for executing functions associated with said displayed converted copy of said at least one file.

18. The method of claim 17, wherein said displaying at least one command button with said converted copy of said at least one file on said web browser comprises said displaying at least one command button selected from the group consisting of a print command button, a cancel command button, and a delete command button.

19. The method of claim 15, further comprising printing on said printing device said at least one file associated with said displayed, converted copy of said at least one file.

20. The method of claim 15, wherein said printing device is selected from the group consisting of a printer, a copier, a scanner, and a multifunction device.

21. A system for displaying a print job stored in a memory of a printing device, comprising:
a printing device;
at least one memory associated with said printing device for storing at least one print job;
a job manager for monitoring said printing device;
a web server associated with said printing device for providing access to said at least one memory;
a web browser for communicating with said web server associated with said printing device; and
at least one program associated with said printing device for communicating data between said printing device and said web browser.

22. A computer-readable medium having computer-executable instructions for viewing a print job stored in a memory of a printing device, comprising:
using a web browser operating on a computer to communicate with a web server associated with said printing device;
retrieving a list of file names from a memory of said printing device;
displaying said list of file names on said web browser;
selecting at least one file name from said list of files names for viewing;
verifying authorization to at least one file associated with said selected at least one file name;
converting a copy of said at least one file associated with said selected at least one file name to a web browser friendly format; and
displaying said compiled copy of said at least one file on said web browser.

23. The computer-readable medium, as recited in claim 22, further comprising computer-executable instructions for displaying command buttons with said displayed list of file names on said web browser for executing functions associated with said displayed list of file names.

24. The computer-readable medium, as recited in claim 22, further comprising computer-executable instructions for displaying at least one command button with said compiled copy of said at least one file on said web browser for executing functions associated with said displayed compiled copy of said at least one file.

25. The computer-readable medium, as recited in claim 24, wherein said computer-executable instructions for displaying at least one command button with said compiled copy of said at least one file on said web browser comprises computer-executable instructions for displaying said at least one command button selected from the group consisting of print command button, a cancel command button, and a delete command button.

26. The computer-readable medium, as recited in claim 22, further comprising computer-executable instructions for printing on said printing device said at least one file associated with said displayed, compiled of said at least one file.
